(19) United States
(12) Patent Application Publication
(10) Pub. No.: US 2026/0348028 A1
(43) Pub. Date: Nov. 5, 2026

(54) CHEMICAL LOOPING-BASED MEMBRANE-FREE WATER ELECTROLYZER FOR HYDROGEN PRODUCTION AND OPERATING METHOD THEREOF

(71) Applicant: SOUTHEAST UNIVERSITY, Nanjing (CN)

(72) Inventors: Rui XIAO, Nanjing (CN); Kunlang LU, Nanjing (CN); Tao LI, Nanjing (CN); Chao LIU, Nanjing (CN); Dewang ZENG, Nanjing (CN)

(73) Assignee: SOUTHEAST UNIVERSITY, Nanjing (CN)

(21) Appl. No.: 19/708,971

(22) Filed: Jun. 16, 2026

Related U.S. Application Data
(63) Continuation of application No. PCT/CN2025/128413, filed on Oct. 17, 2025.

(30) Foreign Application Priority Data
Jan. 16, 2025 (CN) 202510066508.X

(51) Int. Cl. C25B 9/77; C25B 1/04; C25B 9/15; C25B 9/19; C25B 9/65; C25B 11/042; C25B 15/027; C25B 15/08

(52) U.S. Cl. CPC C25B 9/77; C25B 1/04; C25B 9/15; C25B 9/19; C25B 9/65; C25B 11/042; C25B 15/027; C25B 15/087

(57) ABSTRACT

A chemical looping-based membrane-free water electrolysis hydrogen production electrolyzer and an operating method thereof are provided. The electrolyzer includes a first end plate and a second end plate connected respectively with an external power supply, and at least one bipolar plate is disposed between the two end plates; an electrolysis cell is formed between the two end plates and the bipolar plate, and between two adjacent two bipolar plates; each electrolysis cell is internally provided with a functional assembly including a bifunctional electrode, a porous separator and an oxygen carrier electrode sequentially attached. The collaborative use of the bifunctional electrode and the oxygen carrier electrode can catalyze hydrogen evolution and oxygen evolution under different working conditions, adapting to power fluctuation and intermittence of the renewable energy and having the application potential of off-grid hydrogen production.

### CROSS REFERENCE TO THE RELATED APPLICATIONS

This application is a continuation application of International Application No. PCT/CN2025/128413, filed on Oct. 17, 2025, which is based upon and claims priority to Chinese Patent Application No. 202510066508.X, filed on Jan. 16, 2025, the entire contents of which are incorporated herein by reference.

### TECHNICAL FIELD

The present disclosure relates to the field of hydrogen production by water electrolysis and in particular to a chemical looping-based membrane-free water electrolyzer for hydrogen production and operating method thereof.

### BACKGROUND

Due to its high energy density and environmental friendliness, hydrogen is widely recognized as an ideal green energy carrier. But, at present, more than 90% of hydrogen production around the world depends on fossil fuels, which leads to emission of massive carbon dioxide, unfavorable for coping with the climate change. In order to realize carbon-free economy, water electrolysis technology for hydrogen production becomes particularly significant especially in the cases of providing electric energy using the renewable energies such as solar energy and wind energy. This hydrogen production method can not only effectively store redundant electricity of the renewable energy sources but also solve discontinuity problems of the renewable energy in spatio-temporal distribution, thereby promoting sustainable supply and distribution of the energy. The traditional membrane-based water electrolysis technology for hydrogen production faces multiple challenges including potential hazard posed by mixture of hydrogen and oxygen, prohibitive costs of membrane materials, and efficiency loss resulting from membrane resistance and the like. The above issues limit the system capacity, and hinder the mass application of hydrogen production by water electrolysis. Although the research institutes at home and abroad have developed several hundred novel membrane materials in recent years, the membrane-based water electrolysis technology for hydrogen production has made no breakthrough in the contradiction of safety, large capacity and low energy consumption due to limitation of ion transport activity and physicochemical stability of membranes.

For the above, a membrane-free water electrolysis technology emerges, which realizes the spatio-temporal decoupling of hydrogen evolution and oxygen evolution reactions through redox cycle of the oxygen carrier (i.e. chemical looping), featuring intrinsic safety and energy consumption advantages. However, the existing membrane-free electrolysis technology has the problems of low integration of electrolyzer structure, and low hydrogen and oxygen production efficiency and so on.

### SUMMARY

For the above shortcomings of the prior arts, the present disclosure provides a chemical looping-based membrane-free water electrolyzer for hydrogen production and operating method thereof so as to improve the integration degree of the electrolyzer structure and increase the hydrogen production efficiency.

The present disclosure employs the following technical schemes.

The present disclosure provides a chemical looping-based membrane-free water electrolyzer for hydrogen production, wherein the electrolyzer includes a first end plate and a second end plate respectively connected with an external power supply, the first end plate is integrally connected with the second end plate, at least one bipolar plate is disposed between the first end plate and the second end plate, and an electrolysis cell is formed between the two end plates and the bipolar plate and between two adjacent bipolar plates;
each electrolysis cell is internally provided with a functional assembly including a bifunctional electrode, a porous separator and an oxygen carrier electrode sequentially attached, and the bifunctional electrode is used to catalyze hydrogen evolution under a first working condition, and catalyze oxygen evolution under a second working condition; a temperature of an electrolyte is 20 to 50 °C and 50 to 100 °C respectively under the first working condition and the second working condition, and the polarities of the external power supply under the two working conditions are opposite;
a gasket is sleeved on an outer side of the functional assembly;
a gasket sleeved on the outer side of the functional assembly in the electrolysis cell close to the first end plate is not provided with a first up channel, and a first up channel is provided in a thickness direction on an upper part of each of the remaining gaskets;
a first down channel is provided on a lower part of each of all gaskets;
a first flow channel region is provided on both sides of the bipolar plate, and the first flow channel regions at both sides are electrically connected with the oxygen carrier electrode and the bifunctional electrode respectively through conductive columns distributed thereon so that multiple electrolysis cells are series-connected in sequence;
a second up channel is provided in a thickness direction on an upper part of the bipolar plate, a second down channel is provided in a thickness direction on a lower part of the bipolar plate, a first flow guiding channel in communication with the second up channel is disposed on an upper part of the first flow channel region, and a second flow guiding channel in communication with the second down channel is disposed on a lower part of the first flow channel region;
the first down channel and the second down channel are communicated alternately in sequence to form an electrolyte input channel, and the electrolyte in the electrolyte input channel flows through the second flow guiding channels into each electrolysis cell;
the first up channel and the second up channel are communicated alternately in sequence to form a gas-liquid output channel, and electrolysis products and the electrolyte in each electrolysis cell flow through the first flow guiding channels into the gas-liquid output channel;
a second flow channel region is disposed on an inner side of the first end plate, and is connected with the bifunctional electrode via conductive columns, and an inlet is disposed in a thickness direction on the first end plate;
a third flow channel region is disposed on an inner side of the second end plat, and is connected with the oxygen carrier electrode via conductive columns, and an outlet is disposed in a thickness direction on the second end plate;
a first flow guiding channel in communication with the outlet is disposed on an upper part of the third flow channel region, and a second flow guiding channel in communication with the electrolyte input channel is disposed on a lower part of the third flow channel region;
an inlet end of the electrolyte input channel is connected with the inlet, and an outlet end of the gas-liquid output channel is connected with the outlet.

The further technical scheme is as follows:

The first flow guiding channel and the second flow guiding channel are located on the sides of the bipolar plate and the second end plate close to the oxygen carrier electrode.

Depths of the first flow guiding channel and the second flow guiding channel are not greater than one half of a thickness of the bipolar plate.

A material of the bifunctional electrode includes one of metal phosphide, metal sulfide, metal carbide, metal nitride and metal oxide.

A size of the bifunctional electrode is not greater than a size of the oxygen carrier electrode.

The oxygen carrier electrode is an electrode with nickel hydroxide as main constituent.

The porous separator is a hollowed or non-hollowed sheet-shaped structure made of an insulating porous material.

The present disclosure also provides an operating method of the chemical looping-based membrane-free water electrolysis hydrogen production, including stepwise production of hydrogen and oxygen which includes:
by controlling an external power switch, switching the running condition of the electrolyzer so that at least one electrolyzer runs alternately in sequence under a first working condition and a second working condition, realizing stepwise production of hydrogen and oxygen in a same space; wherein,
the first working condition: in an electrolyte of 20-50 °C, the first end plate and the second end plate are respectively connected with a negative pole and a positive pole of an external power supply; after being powered, the bifunctional electrode promotes the water electrolysis reaction for hydrogen production, and the active component in the oxygen carrier electrode is oxidized into an oxidized oxygen carrier, and hydrogen is output via the gas-liquid output channel;
the second working condition: in an electrolyte of 50 to 100 °C, the polarity of the external power supply is reversed, namely, the first end plate and the second end plate are respectively connected to the positive pole and the negative pole of the external power supply; after being powered, the bifunctional electrode promotes water electrolysis oxygen production, and the oxidized oxygen carrier in the oxygen carrier electrode is partly reduced spontaneously under the action of the temperature field and meanwhile, is completely reduced under the action of the electric field, and oxygen is output via the gas-liquid output channel.

The further technical scheme is as follows:

The operating method further including hydrogen and oxygen continuous production, which includes:
by using at least one electrolyzer, forming a first group of electrolyzers and by using at least one electrolyzer, forming a second group of electrolyzers;
by controlling the external power switch, switching the running condition of the electrolyzers so that the first group of electrolyzers run alternately in sequence under the first working condition and the second working condition, while the second group of electrolyzers run alternately in sequence under the second working condition and the first working condition, realizing continuous production of hydrogen and oxygen in different spaces.

The electrolyte is KOH or NaOH solution.

The present disclosure has the following beneficial effects.
1. In the present disclosure, a bifunctional electrode is introduced in the electrolyzer. This electrode can catalyze not only the hydrogen evolution reaction but also the oxygen evolution reaction, so as to improve the integration degree of the electrolyzer system. Further, the use of the precious metal materials is avoided and the equipment costs are lowered remarkably.
2. In the present disclosure, through redox cycle of the electrode of the oxygen carrier, hydrogen production and oxygen production are carried out stepwise in a same electrolyzer. Coupled with the bifunctional electrode, hydrogen production and oxygen production can be carried out under different voltage conditions, significantly adapting to the power fluctuation and intermittence of the renewable energy, and having the potential of off-grid hydrogen production.
3. In the present disclosure, by coupling of the temperature field and electric field, the electrolysis system is powered. During the hydrogen production stage, the oxygen carrier is oxidized under the action of the low-temperature electric field, inhibiting the occurrence of the competitive oxygen evolution reaction. During the oxygen production stage, the oxidized oxygen carrier is reduced under the joint action of the temperature field and the electric field, ensuring complete regeneration of the oxygen carrier, obviously increasing the regeneration rate of the oxygen carrier, solving the problem of rate limitation of the oxygen evolution reaction, and greatly improving the hydrogen production cycle efficiency. In addition, due to the effect of the temperature field, the oxygen production voltage is greatly reduced, remarkably lowering the comprehensive hydrogen production cost.

Other features and advantages of the present disclosure will be set out in the subsequent specification and partly become apparent from the specification or be known by practice of the present disclosure.

### BRIEF DESCRIPTION OF THE DRAWINGS

FIG. 1 is a structural schematic diagram illustrating an electrolyzer of a membrane-free water electrolyzer for hydrogen production according to an embodiment of the present disclosure.

FIG. 2 is a structural schematic diagram illustrating a gasket according to an embodiment of the present disclosure.

FIG. 3 is a structural schematic diagram illustrating a bipolar plate according to an embodiment of the present disclosure.

FIG. 4 is a structural schematic diagram illustrating a first end plate according to an embodiment of the present disclosure.

FIG. 5 is a structural schematic diagram illustrating a second end plate according to an embodiment of the present disclosure.

FIGS. 6A-6B are cell voltage curves obtained by testing a single electrolysis cell according to a control embodiment and an embodiment 2 of the present disclosure.

In the drawings, 1. electrolysis cell, 2. bipolar plate, 3. electrolyte input channel, 4. gas-liquid output channel, 5. first end plate, 6. second end plate, 7. first flow guiding channel, 8. second flow guiding channel, 9. nut, 10. bolt, 101. bifunctional electrode, 102. porous separator, 103. oxygen carrier electrode, 104. gasket, 201. first flow channel region, 301. first down channel, 302. second down channel, 401. first up channel, 402. second up channel, 501. second flow channel region, 601. third flow channel region, 3011. inlet, and 4021. outlet.

### DETAILED DESCRIPTION OF THE EMBODIMENTS

The specific embodiments of the present disclosure will be described below in combination with drawings.

### Embodiment 1

As shown in FIG. 1, a chemical looping-based membrane-free water electrolyzer for hydrogen production according to this embodiment, wherein the electrolyzer includes a first end plate 5 and a second end plate 6 respectively connected with an external power supply, the first end plate 5 is integrally connected with the second end plate 6, at least one bipolar plate 2 is disposed between the first end plate 5 and the second end plate 6, and an electrolysis cell 1 is formed between the two end plates and the bipolar plate 2 and between two adjacent bipolar plates 2;
each electrolysis cell 1 is internally provided with a functional assembly including a bifunctional electrode 101, a porous separator 102 and an oxygen carrier electrode 103 sequentially attached, and the bifunctional electrode 101 is used to catalyze hydrogen evolution under a first working condition, and catalyze oxygen evolution under a second working condition; a temperature of an electrolyte is 20 to 50 °C and 50 to 100 °C respectively under the first working condition and the second working condition, and the polarities of the external power supply under the two working conditions are opposite;
a gasket 104 is sleeved on an outer side of the functional assembly;

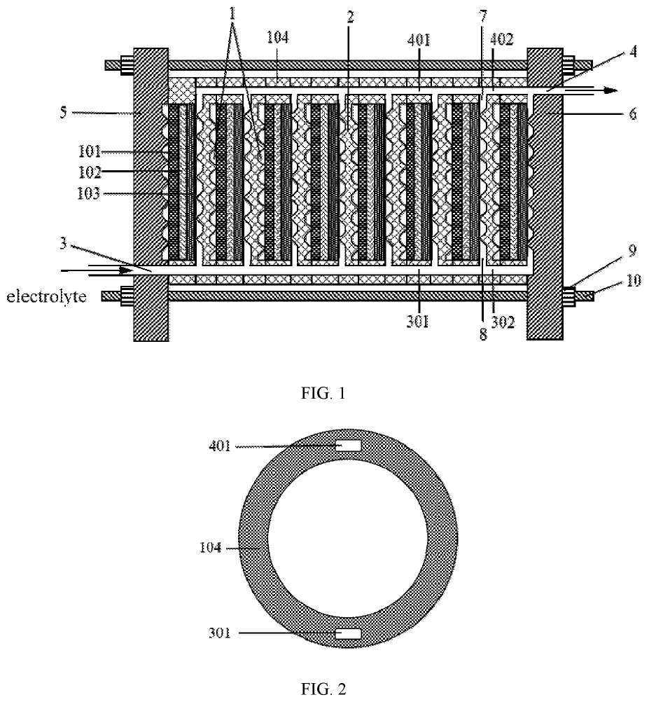

As shown in FIG. 1 and FIG. 2, a gasket sleeved on the outer side of the functional assembly in the electrolysis cell 1 close to the first end plate 5 is not provided with a first up channel 401, and a first up channel 401 is provided in a thickness direction on an upper part of each of the remaining gaskets 104; a first down channel 301 is provided on a lower part of each of all gaskets 104;
both sides of the bipolar plate 2 are respectively connected with the oxygen carrier electrode 103 and the bifunctional electrode 101 of two adjacent electrolysis cells and a flow channel is formed so that multiple electrolysis cells 1 are series-connected in sequence.

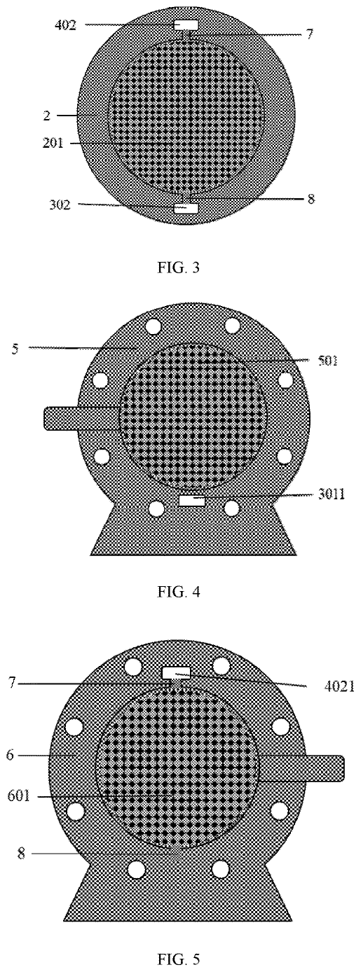

Specifically, as shown in FIG. 1 and FIG. 3, a first flow channel region 201 is provided on both sides of the bipolar plate 2, and the first flow channel regions 201 at both sides are electrically connected with the oxygen carrier electrode 103 and the bifunctional electrode 101 respectively through conductive columns distributed thereon so that multiple electrolysis cells 1 are series-connected in sequence.

An upper part of the bipolar plate 2 is provided with a second up channel 402 in a thickness direction and a lower part of the bipolar plate 2 is provided with a second down channel 302 in a thickness direction; a first flow guiding channel 7 in communication with the second up channel 402 is disposed on an upper part of the first flow channel region 201, and a second flow guiding channel 8 in communication with the second down channel 302 is disposed on a lower part of the first flow channel region 201.

As shown in FIG. 1, the first down channels 301 and the second down channels 302 are alternately communicated in sequence to form an electrolyte input channel 3, and the electrolyte in the electrolyte input channel 3 flows through the second flow guiding channels 8 into each electrolysis cell 1; the first up channel 401 and the second up channel 402 are alternately communicated in sequence to form a gas-liquid output channel 4, and a post-electrolysis reactant in each electrolysis cell 1 flows through the first flow guiding channel 7 into the gas-liquid output channel 4.

With reference to FIGS. 4 and 5, a second flow channel region 501 is disposed at an inner side of the first end plate 5, and connected with the bifunctional electrode 101 through conductive columns, and an inlet 3011 is disposed in a thickness direction on the first end plate 5. A third flow channel region 601 is disposed at an inner side of the second end plate 6, and connected with the oxygen carrier electrode 103 through conductive columns, and an outlet 4021 is disposed in a thickness direction on the second end plate 6. The first flow guiding channel 7 in communication with the outlet 4021 is disposed on an upper part of the third flow channel region 601, and the second flow guiding channel 8 in communication with the electrolyte input channel 3 is disposed on a lower part of the third flow channel region 601.

An inlet end of the electrolyte input channel 3 is connected with the inlet 3011 to transport electrolyte into the electrolyzer. An outlet end of the gas-liquid output channel 4 is connected with the outlet 4021 to transport a post-electrolysis hydrogen or oxygen product and electrolyte outwardly.

The first end plate 5 and the second end plate 6 are further provided with a power connection post and a bolt hole. As a specific embodiment, the first end plate 5 and the second end plate 6 can be fixedly connected using a nut 9 and a bolt 10, and thus, each gasket 104 and each bipolar plate 2 are tightly pressed so that each electrolysis cell is fixed.

The first flow guiding channel 7 and the second flow guiding channel 8 are located on the sides of the bipolar plate 2 and the second end plate 6 close to the oxygen carrier electrode 103, and depths of the first flow guiding channel 7 and the second flow guiding channel 8 are not greater than one half of a thickness of the bipolar plate 2.

In this embodiment, the material of the bifunctional electrode 101 includes one of metal phosphide, metal sulfide, metal carbide, metal nitride and metal oxide. Specifically, the bifunctional electrode 101 is CoFeNiPOx electrodeposited in situ on a nickel foam.

In this embodiment, a size of the bifunctional electrode 101 is not greater than a size of the oxygen carrier electrode 103. The size of the bifunctional electrode 101 is specifically one third of the size of the oxygen carrier electrode 103.

In this embodiment, the porous separator 102 is made of an insulated porous material prevent short-circuiting of the bifunctional electrode 101 and the oxygen carrier electrode 103. Specifically, the porous separator 102 is a glass fiber separator.

In this embodiment, the oxygen carrier electrode 103 is an electrode with nickel hydroxide as active component, and specifically, is nickel foam-supported Ni_{0.9}Co_{0.1}(OH)₂.

As a preferred embodiment, a section of the bifunctional electrode 101 and the oxygen carrier electrode 103 is circular, and a section of the bipolar plate 2 is circular, and the porous separator 102 is one of an annulus, a full-size circle and a hollowed circle.

### Embodiment 2

This embodiment provides an operating method of the chemical looping-based membrane-free water electrolyzer for hydrogen production in the embodiment 1, which includes stepwise production of hydrogen and oxygen.

The stepwise production of hydrogen and oxygen specifically includes the followings.

By controlling an external power switch, the running condition of the electrolyzer is switched so that at least one electrolyzer runs alternately in sequence under a first working condition and second working condition, realizing stepwise production of hydrogen and oxygen in a same space.

The first working condition: in a 5 M KOH electrolyte of 25 °C, the first end plate 5 and the second end plate 6 are respectively connected with a negative pole and a positive pole of an external power supply; after being powered, the bifunctional electrode 101 promotes the water electrolysis reaction for hydrogen production, and the active component in the oxygen carrier electrode 103 is oxidized into an oxidized oxygen carrier, and hydrogen is output via the gas-liquid output channel 4.

The second working condition: in a 5 M KOH electrolyte of 90 °C, the polarity of the external power supply is reversed, namely, the first end plate 5 and the second end plate 6 are respectively connected to the positive pole and the negative pole of the external power supply; after being powered, the bifunctional electrode 101 promotes water electrolysis oxygen production, and the oxidized oxygen carrier in the oxygen carrier electrode 103 is partly reduced spontaneously under the action of the temperature field and meanwhile, is completely reduced under the action of the electric field, and oxygen is output via the gas-liquid output channel 4.

### Control Embodiment

This control embodiment provides an operating method of the chemical looping-based membrane-free water electrolyzer for hydrogen production in the embodiment 1, which differs from the embodiment 2 in that: the temperature of the electrolyte is 25 °C, namely, the electrolysis process is powered only by the electric field.

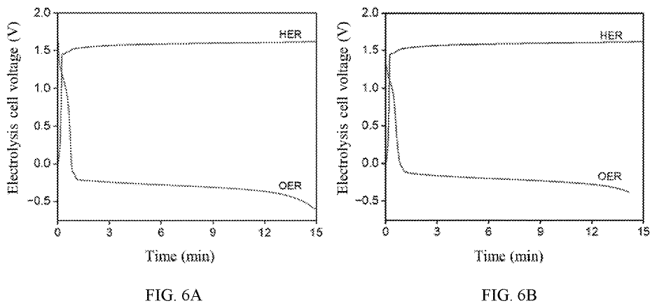

Under the hydrogen production current density of 100 mA cm⁻², a single electrolysis cell of the control embodiment and the embodiment 2 is tested, with the obtained cell voltage data shown in FIG. 6A and FIG. 6B.

Compared with the control embodiment in which energy is supplied only by the electric field, the joint effect of the temperature field and the electric field in the embodiment 2 significantly lowers the oxygen production voltage. Further, since the oxygen carrier undergoes spontaneous reduction under the action of the temperature field, the regeneration rate of the oxygen carrier is increased, and the hydrogen production efficiency is greatly higher than under the condition of being powered solely by the electric field. Therefore, the coupling of the temperature field and the electric field for energy supply remarkably increases the hydrogen production cycle efficiency.

### Embodiment 3

This embodiment provides an operating method of the the chemical looping-based membrane-free water electrolyzer for hydrogen production in the embodiment 1, which includes continuous production of hydrogen and oxygen.

The continuous production of hydrogen and oxygen includes the following.

By using at least one electrolyzer, a first group of electrolyzers is formed, and by using at least one electrolyzer, a second group of electrolyzers is formed.

By controlling the external power switch, the running condition of the electrolyzers is switched so that the first group of electrolyzers run alternately in sequence under the first working condition and the second working condition, while the second group of electrolyzers run alternately in sequence under the second working condition and the first working condition, realizing continuous production of hydrogen and oxygen in different spaces.

Persons of ordinary skills in the arts can understand that the above are preferred embodiments of the present disclosure and not intended to limit the present disclosure. Although detailed descriptions are made to the present disclosure by referring to the preceding embodiments, those skilled in the arts can still modify the technical solutions recorded in the above embodiments or make equivalent replacement to partial technical features therein. Any modifications, equivalent replacements and improvements and so on made within the spirit and principle of the present disclosure shall all fall within the scope of protection of the present disclosure.

What is claimed is:

1. A chemical looping-based membrane-free water electrolyzer for hydrogen production, wherein the electrolyzer comprises a first end plate and a second end plate respectively connected with an external power supply, the first end plate is integrally connected with the second end plate, at least one bipolar plate is disposed between the first end plate and the second end plate, and an electrolysis cell is formed between the two end plates and the bipolar plate and between two adjacent bipolar plates;
each electrolysis cell is internally provided with a functional assembly comprising a bifunctional electrode, a porous separator, and an oxygen carrier electrode sequentially attached, and the bifunctional electrode is used to catalyze hydrogen evolution under a first working condition, and catalyze oxygen evolution under a second working condition; a temperature of an electrolyte is 20 to 50 °C and 50 to 100 °C respectively under the first working condition and the second working condition, and polarities of the external power supply under the two working conditions are opposite;
a gasket is sleeved on an outer side of the functional assembly;
a gasket sleeved on the outer side of the functional assembly in the electrolysis cell close to the first end plate is not provided with a first up channel, and a first up channel is provided in a thickness direction on an upper part of each of the remaining gaskets;
a first down channel is provided on a lower part of each of all gaskets;
a first flow channel region is provided on both sides of the bipolar plate, and the first flow channel regions at both sides are electrically connected with the oxygen carrier electrode and the bifunctional electrode respectively through conductive columns distributed thereon so that multiple electrolysis cells are series-connected in sequence;
a second up channel is provided in a thickness direction on an upper part of the bipolar plate, a second down channel is provided in a thickness direction on a lower part of the bipolar plate, a first flow guiding channel in communication with the second up channel is disposed on an upper part of the first flow channel region, and a second flow guiding channel in communication with the second down channel is disposed on a lower part of the first flow channel region;
the first down channel and the second down channel are communicated alternately in sequence to form an electrolyte input channel, and the electrolyte in the electrolyte input channel flows through the second flow guiding channels into each electrolysis cell;
the first up channel and the second up channel are communicated alternately in sequence to form a gas-liquid output channel, and electrolysis products and the electrolyte in each electrolysis cell flow through the first flow guiding channels into the gas-liquid output channel;
a second flow channel region is disposed on an inner side of the first end plate, and is connected with the bifunctional electrode via conductive columns, and an inlet is disposed in a thickness direction on the first end plate;
a third flow channel region is disposed on an inner side of the second end plate, and is connected with the oxygen carrier electrode via conductive columns, and an outlet is disposed in a thickness direction on the second end plate;
the first flow guiding channel in communication with the outlet is disposed on an upper part of the third flow channel region, and the second flow guiding channel in communication with the electrolyte input channel is disposed on a lower part of the third flow channel region;
an inlet end of the electrolyte input channel is connected with the inlet, and an outlet end of the gas-liquid output channel is connected with the outlet;
the first flow guiding channel and the second flow guiding channel are located on sides of the bipolar plate and the second end plate close to the oxygen carrier electrode;
depths of the first flow guiding channel and the second flow guiding channel are not greater than one half of a thickness of the bipolar plate.

2. The chemical looping-based membrane-free water electrolyzer for hydrogen production according to claim 1, wherein a material of the bifunctional electrode comprises one of metal phosphide, metal sulfide, metal carbide, metal nitride, and metal oxide.

3. The chemical looping-based membrane-free water electrolyzer for hydrogen production according to claim 1, wherein a size of the bifunctional electrode is not greater than a size of the oxygen carrier electrode.

4. The chemical looping-based membrane-free water electrolyzer for hydrogen production according to claim 1, wherein the oxygen carrier electrode is an electrode with nickel hydroxide as main constituent.

5. The chemical looping-based membrane-free water electrolyzer for hydrogen production according to claim 1, wherein the porous separator is a hollowed or non-hollowed sheet-shaped structure made of an insulating porous material.

6. An operating method of the chemical looping-based membrane-free water electrolyzer for hydrogen production according to claim 1, comprising stepwise production of hydrogen and oxygen which comprises:
by controlling an external power switch, switching a running condition of the electrolyzer so that at least one electrolyzer runs alternately in sequence under the first working condition and the second working condition, realizing stepwise production of hydrogen and oxygen in a same space; wherein,
the first working condition: in an electrolyte of 20-50 °C, the first end plate and the second end plate are respectively connected with a negative pole and a positive pole of the external power supply; after being powered, the bifunctional electrode promotes the water electrolysis reaction for hydrogen production, and an active component in the oxygen carrier electrode is oxidized into an oxidized oxygen carrier, and hydrogen is output via the gas-liquid output channel;
the second working condition: in an electrolyte of 50 to 100 °C, the polarity of the external power supply is reversed, namely, the first end plate and the second end plate are respectively connected to the positive pole and the negative pole of the external power supply; after being powered, the bifunctional electrode promotes water electrolysis oxygen production, and the oxidized oxygen carrier in the oxygen carrier electrode is partly reduced spontaneously under the action of a temperature field and meanwhile, is completely reduced under the action of an electric field, and oxygen is output via the gas-liquid output channel.

7. The operating method according to claim 6, further comprising hydrogen and oxygen continuous production, which comprises:
by using at least one electrolyzer, forming a first group of electrolyzers and by using at least one electrolyzer, forming a second group of electrolyzers;
by controlling the external power switch, switching the running condition of the electrolyzers so that the first group of electrolyzers run alternately in sequence under the first working condition and the second working condition, while the second group of electrolyzers run alternately in sequence under the second working condition and the first working condition, realizing continuous production of hydrogen and oxygen in different spaces.

8. The operating method according to claim 6, wherein the electrolyte is KOH or NaOH solution.

9. The operating method according to claim 6, wherein in the electrolyzer, a material of the bifunctional electrode comprises one of metal phosphide, metal sulfide, metal carbide, metal nitride, and metal oxide.

10. The operating method according to claim 6, wherein in the electrolyzer, a size of the bifunctional electrode is not greater than a size of the oxygen carrier electrode.

11. The operating method according to claim 6, wherein in the electrolyzer, the oxygen carrier electrode is an electrode with nickel hydroxide as main constituent.

12. The operating method according to claim 6, wherein in the electrolyzer, the porous separator is a hollowed or non-hollowed sheet-shaped structure made of an insulating porous material.

13. The operating method according to claim 9, further comprising hydrogen and oxygen continuous production, which comprises:
by using at least one electrolyzer, forming a first group of electrolyzers and by using at least one electrolyzer, forming a second group of electrolyzers;
by controlling the external power switch, switching the running condition of the electrolyzers so that the first group of electrolyzers run alternately in sequence under the first working condition and the second working condition, while the second group of electrolyzers run alternately in sequence under the second working condition and the first working condition, realizing continuous production of hydrogen and oxygen in different spaces.

14. The operating method according to claim 10, further comprising hydrogen and oxygen continuous production, which comprises:
by using at least one electrolyzer, forming a first group of electrolyzers and by using at least one electrolyzer, forming a second group of electrolyzers;
by controlling the external power switch, switching the running condition of the electrolyzers so that the first group of electrolyzers run alternately in sequence under the first working condition and the second working condition, while the second group of electrolyzers run alternately in sequence under the second working condition and the first working condition, realizing continuous production of hydrogen and oxygen in different spaces.

15. The operating method according to claim 11, further comprising hydrogen and oxygen continuous production, which comprises:
by using at least one electrolyzer, forming a first group of electrolyzers and by using at least one electrolyzer, forming a second group of electrolyzers;
by controlling the external power switch, switching the running condition of the electrolyzers so that the first group of electrolyzers run alternately in sequence under the first working condition and the second working condition, while the second group of electrolyzers run alternately in sequence under the second working condition and the first working condition, realizing continuous production of hydrogen and oxygen in different spaces.

16. The operating method according to claim 12, further comprising hydrogen and oxygen continuous production, which comprises:
by using at least one electrolyzer, forming a first group of electrolyzers and by using at least one electrolyzer, forming a second group of electrolyzers;
by controlling the external power switch, switching the running condition of the electrolyzers so that the first group of electrolyzers run alternately in sequence under the first working condition and the second working condition, while the second group of electrolyzers run alternately in sequence under the second working condition and the first working condition, realizing continuous production of hydrogen and oxygen in different spaces.

17. The operating method according to claim 9, wherein the electrolyte is KOH or NaOH solution.

18. The operating method according to claim 10, wherein the electrolyte is KOH or NaOH solution.

19. The operating method according to claim 11, wherein the electrolyte is KOH or NaOH solution.

20. The operating method according to claim 12, wherein the electrolyte is KOH or NaOH solution.
